(19) United States
(12) Patent Application Publication
(10) Pub. No.: US 2019/0373903 A1
(43) Pub. Date: Dec. 12, 2019

(54) TREATMENT SYSTEM AND METHOD FOR SICK AND DEAD LIVESTOCK AND POULTRY

(71) Applicants: Shen WANG, CHANGSHA (CN); HUNAN SAKAL ENVIRONMENTAL SCIENCE AND TECHNOLOGY CO., LTD., CHANGSHA (CN)

(72) Inventor: Shen WANG, CHANGSHA (CN)

(21) Appl. No.: 16/529,177

(22) Filed: Aug. 1, 2019

Related U.S. Application Data
(63) Continuation of application No. PCT/CN2017/106632, filed on Oct. 18, 2017.

(30) Foreign Application Priority Data
Oct. 12, 2017 (CN) 201710944200.6

(51) Int. Cl. A22B 1/00; B09B 3/00; A22B 3/08

(52) U.S. Cl. CPC A22B 1/00; A22B 3/08; B09B 3/0091

(57) ABSTRACT

A treatment system for sick and dead livestock and poultry, including a cracking and propagation system, a heating and heat balancing system, a waste gas treatment system and a detection and control system. The heating and heat balancing system is connected with a water jacket and a coil of the cracking and propagation system by pipes. A waste gas exhaust pipe of the cracking and propagation system is connected with the waste gas treatment system. The detection and control system controls connection of the above systems. The present invention creatively designs pollution treatment equipment, innovates the treatment mode, soaks sick and dead livestock and poultry and placentas in livestock and poultry manure liquid for cracking and fermentation and turns waste into wealth, so that not only the sick and dead livestock and poultry and placentas are completely harmless, but also a resource utilization rate is maximized.

### CROSS-REFERENCE TO RELATED APPLICATIONS

This application is a continuation of International Patent Application No. PCT/CN2017/106632 with a filing date of Oct. 18, 2017, designating the United States, now pending, and further claims priority to Chinese Patent Application No 201710944200.6 with a filing date of Oct. 12, 2017. The content of the aforementioned applications, including any intervening amendments thereto, are incorporated herein by reference.

### TECHNICAL FIELD

The present invention belongs to the technical field of environmental protection, and particularly relates to a treatment system and method for sick and dead livestock and poultry.

### BACKGROUND OF THE PRESENT INVENTION

Harmless treatment of sick and dead livestock and poultry is an important initiative to prevent the spread of livestock and poultry epidemic, effectively control and exterminate the livestock and poultry epidemic and prevent pathogens from polluting the environment. In recent years, rapid intensive and large-scale development of the breeding industry has provided abundant and high-quality livestock and poultry products for the market, and has also brought a large amount of pollutants such as sick and dead livestock and poultry. It is estimated that the annual mortality rate of adult livestock and poultry is 2%-3%, the mortality rate of middle livestock and poultry is 7%-8%, and the mortality rate of suckling livestock and poultry is up to 10%. In the event of an epidemic, the proportion will be even greater. If there is no timely and effective treatment, a serious pollution will be caused to the rural environment.

At present, methods for harmless treatment of sick and dead livestock and poultry mainly include incineration, landfilling, high-temperature composting and chemical production methods. The water content of livestock and poultry exceeds 70%, so incineration is relatively hard to be realized and incomplete and the energy consumption is high. Serious secondary pollution may be easily produced due to high water content and insufficient combustion. At present, the landfilling mode is commonly applied Animal carcasses are landfilled by digging in the wild or in the place where the epidemic occurred. The landfilling costs are high, but the subsidies for the sick and dead livestock and poultry are much lower than the landfilling costs. Most of workers of the farms fail to do sanitary landfilling due to lack of health and safety knowledge, thereby causing serious secondary pollution The high-temperature composting method has disadvantages that mechanical loss, energy consumption and equipment cleaning in crushing of the sick and dead livestock and poultry and other pretreatment processes will increase treatment costs; operators will be prone to cross infection in processes of crushing of the sick and dead livestock and poultry, equipment cleaning and replacement of wearing part, thereby increasing a risk of epidemic spread; the composting method is large in occupied area, long in time and easy to be affected by climatic conditions, and the sick and dead livestock and poultry carry a large number of pathogenic microorganisms, which are hard to be completely killed by traditional fermentation modes. The chemical production method is a method for realizing complete harmlessness of the sick and dead livestock and poultry by high temperature and high pressure in a closed container. A large amount of condensed water and cracking liquid are generated during treatment with the traditional methods. The condensed water still needs to be discharged after being environmentally treated to reach a standard. The cracking liquid is generally dried to form powder. The chemical production method has disadvantages that the energy consumption is high in the drying process, a large amount of condensed water is generated, and the treatment costs are greatly increased.

CN 105689364A discloses a method for harmless treatment of sick and dead livestock and poultry, including: disintegrating sick and dead livestock and poultry bodies at first; directly sterilizing, drying or carbonizing with hot gas at 120-320° C.; pressing the sterilized and dried meat, hair and bone substances; flowing oil obtained during pressing into a collecting tank; and preparing the remaining meat, hair and bone substances after pressing into animal feed or carbonizing and then landfilling. The method has the following disadvantages: (1) the process of crushing the sick and dead livestock and poultry increases the treatment costs, is prone to cross infection, and increases the risk of epidemic spread; (2) the process of drying or carbonizing has high energy consumption, long treatment time and high cost, also generates a lot of waste water and waste gas, has high treatment costs and is prone to secondary pollution; and (3) the sick and dead livestock and poultry are rich in organic matters such as protein and fat, major, medium and trace elements as well as inorganic salts, so the landfilling wastes resources and has a low resource utilization rate.

### SUMMARY OF PRESENT INVENTION

A technical problem to be solved by the present invention is to provide a treatment system and method for sick and dead livestock and poultry, for conducting harmless treatment and resource utilization of sick and dead livestock and poultry and placentas to prepare a microbial culture solution to be sprayed into an organic fertilizer to obtain a bio-organic fertilizer, in order to solve problems existing in the background.

The present invention adopts a technical solution as follows. A treatment system for sick and dead livestock and poultry comprises a cracking and propagation system, a heating and heat balancing system, a waste gas treatment system and a detection and control system, wherein the heating and heat balancing system is connected with a water jacket and a coil of the cracking and propagation system by pipes, a waste gas exhaust pipe of the cracking and propagation system is connected with the waste gas treatment system, sensors of the detection and control system are arranged in the corresponding systems, to detect various key parameters; and the detection and control system controls connection of the above systems,

wherein the cracking and propagation system is composed of Y cracking and propagation reactors (Y≥2), X cracking reactors (X≥1), Z propagation reactors (Z≥1), steam generators, aeration fans, air filters, electromagnetic valves and connecting pipes; livestock and poultry manure liquid is respectively inputted into feed pipes of the cracking and propagation reactors and the cracking reactors; and discharge pipes of the cracking reactors are connected to the propagation reactors; discharge pipes of the cracking and propagation reactors and the propagation reactors are respectively connected to a liquid storage tank through pipes; steam outlets of the steam generators are respectively connected with steam inlets of aeration pipes of the cracking and propagation reactors and the propagation reactors through a one-way valve, an electromagnetic valve and a steam conveying pipe; the aeration fans are connected with input ends of the air filters through pipes; and output ends of the air filters are respectively connected with another air inlet on a tee joint of the aeration pipes of the cracking and propagation reactors through a one-way valve, an electromagnetic valve and a steam conveying pipe.

In the above solution, each cracking and propagation reactor comprises a support, a tank body, a sealing cover and a conveying device; each tank body is fixed on a base; one side of each tank body is sealed by the sealing cover; a cover sealing door is mounted at the other side of each tank body, each cover sealing door is hinged to the tank body; the cover sealing door is locked and sealed with a plurality of locking bolts when closed, so that a closed cracking and propagation space is formed among the sealing cover, the tank body and the cover sealing door; the tank body is horizontally arranged; rails parallel to an axis of the tank body and radially fixed along, the tank body are arranged in the tank body for bearing and conveying net cages carrying the sick and dead livestock and poultry and placentas; aeration pipes and a plurality of aeration heads are mounted at lower parts of the rails; one end of each aeration pipe is sealed, while the other end extends to the outside of the tank body by the sealing cover and is sequentially connected with air outlets of the electromagnetic valve, the one-way valve, the air filters and the aeration fan and steam outlets of the electromagnetic valve, the one-way valve and the steam generator; an exhaust pipe and a feed pipe are arranged at an upper side of each sealing cover; a pressure sensor and a safety valve are further mounted at the upper side of the sealing cover; a temperature sensor and a discharge pipe are mounted at a lower side of the sealing cover; a water jacket is mounted outside each horizontally arranged tank body for cooling, each cracking and propagation reactor; a circulating water inlet pipe of the water jacket is arranged at a lower part of the tank body; a circulating water drainage pipe of the water jacket is arranged at an upper part of the tank body; and the water jacket is covered with a thermal insulation layer made of thermal insulation material

In the above solution, in order to timely and harmlessly treat the sick and dead livestock and poultry (especially small-sized livestock and poultry) and the placentas, the racking reactors are also provided. Each cracking reactor is composed of a support, a tank body, a sealing cover and a conveying device. Each tank body is fixed on a base. One side of the tank body is sealed by the sealing cover. A cover sealing door is mounted at the other side of the tank body Each cover sealing door is hinged to the tank body. The cover sealing door is locked and sealed with a plurality of lock bolts when closed, so that a closed cracking and propagation space is formed among the sealing cover, the tank body and the cover sealing door. The tank body is horizontally arranged. Rails parallel to an axis of the tank body and radially fixed along the tank body are arranged in the tank body for bearing and conveying, net cages carrying the sick and dead livestock and poultry and placentas; and aeration pipes and a plurality of aeration heads are mounted at lower parts of the rails. The other end of each aeration pipe is sealed, extends to the outside of the tank body by the sealing cover and is sequentially connected with the steam outlets of the electromagnetic valve, the one-way valve and the steam generator. An exhaust pipe and a feed pipe are arranged at an upper part of the sealing cover. A pressure sensor and a safety valve are further mounted at the upper part of the sealing cover. A temperature sensor and a discharge pipe are mounted at a lower part of the sealing cover. A water jacket is mounted outside each horizontally arranged tank body for cooling each cracking and propagation reactor. A circulating water inlet pipe of the water jacket is arranged at the lower part of the tank body. A circulating water drainage pipe of the water jacket is arranged at the upper part of the tank body. The water jacket is covered with the thermal insulation layer made of the thermal insulation material.

In the above solution, each conveying device comprises a trolley and a net cage; a guide rail is fixed on the upper part of the trolley, the net cage is placed on the guide rail, the net cage is a rectangular cage composed of a cage body and steel wire meshes, the surrounding and bottom steel wire meshes are welded on the cage body; a movable cage cover is arranged at the top of the cage body; the cage cover is hinged to the cage body; a handle is further arranged outside the cage cover; a plurality of rollers are fixed at the bottom of the cage body; the rollers are in contact with the guide rail; the direction of the guide rail on the trolley is the same as that of the rail in the tank body, and is flush with the rail in the tank; and when the sick and dead livestock and poultry are conveyed, the sick and dead livestock and poultry are first placed in the net cage through a forklift, and then are conveyed to a specified position in the tank body by the net cage along the rails in the trolley and the tank body.

In the above technical solution, in order to treat cracking liquids outputted by the plurality of small cracking reactors, propagation reactors are specially provided. Each propagation reactor is composed of a vertical and closed thermal insulation tank body, a coil and an aeration device. An aeration port, a coil circulating water outlet, a coil circulating water inlet and an exhaust port are formed in the top of the tank body, while a discharge port is formed in the bottom. The coil is fixed in the tank body and is immersed in the cracking liquid. The aeration device is arranged at the bottom of the tank body. The aeration pipe is connected with the aeration port and is sequentially connected with air outlets of the electromagnetic valve, the air filter and the aeration fan. The thermal insulation tank body is covered with the thermal insulation layer made of the thermal insulation material.

In the above solution, the heating and heat balancing system is composed of an atmospheric pressure hot water boiler, E high-temperature thermal insulation water tanks (E≥1), F low-temperature thermal insulation water tanks (F≥1), circulating water pumps, electromagnetic valves and connecting pipes; further, for regions with abundant solar energy resources, the heating and heat balancing system also comprises a solar heating system; the high-temperature thermal insulation water tanks are water sources of the atmospheric pressure hot water boiler, the solar heating system and the steam generator; water outlet pipes of the high temperature thermal insulation water tanks are connected with the water pumps and respectively convey hot water to the atmospheric pressure hot water boiler, the solar heating system and the steam generator; the high-temperature thermal insulation water tanks are covered with thermal insulation layers made of the thermal insulation materials; the water heated by the atmospheric pressure hot water boiler and the solar heating system is sent back to the high-temperature thermal insulation water tanks through respective pipes for realizing energy storage; the other water outlet pipe of each high-temperature thermal insulation water tank is connected with the water pump to respectively convey the hot water to the cracking and propagation reactors, the cracking reactors and the propagation reactors; return water of each reactor is sent back to each high-temperature thermal insulation water tank through respective water returning pipe; the low-temperature thermal insulation water tanks are water sources of the high-temperature thermal insulation water tanks; the low-temperature thermal insulation water tanks are arranged above the high-temperature thermal insulation water tanks and automatically replenish water to the high-temperature thermal insulation water tanks under control of the detection and control system, the other water outlet pipe of each low-temperature thermal insulation water tank is respectively connected with the water jackets of the cracking and propagation reactors and the cracking reactors through the pumps; the water is sent back to the low-temperature thermal insulation water tanks through respective water returning pipes to realize circulation; and the low-temperature thermal insulation water tanks are covered with thermal insulation layers made of the thermal insulation materials.

In the above solution, energy sources of the steam generators and the atmospheric pressure hot water boilers comprise one or more of electricity, biogas, diesel, biomass fuel, coal and solar energy.

In the above solution, the waste gas treatment system comprises draught fans, biological deodorization filter towers and connecting pipes; the aeration ports of the cracking and propagation reactors are respectively connected with the air filters and the aeration fans successively through the pipes; exhaust pipes of the cracking and propagation reactors, the cracking reactors and the propagation reactors are respectively connected to input ends of the draught fans; the output ends of the draught fans are connected with gas inlets of the biological deodorization filter towers through the pipes; and the exhaust ports of the biological deodorization filter towers are communicated with the atmosphere through the vertical pipes.

Based on the same inventive concept, the present invention al so provides a treatment method based on the above treatment system for sick and dead livestock and poultry, comprising the following steps:

I. cracking of sick and dead livestock and poultry and placentas:

(1) under control of a detection and control system, tap water is automatically replenished to low-temperature thermal insulation water tanks; the low-temperature thermal insulation water tanks automatically replenish the water to high-temperature thermal insulation water tanks by utilizing a height difference; circulating pumps of an atmospheric pressure hot water boiler and a solar heating system are started; the water of the high-temperature thermal insulation water tanks is transferred to the atmospheric pressure hot water boiler and the solar heating system by the circulating pumps for heating and then is transferred to the high-temperature thermal insulation water tanks for energy storage;

(2) a forklift or other transfer equipment is used to place relatively large sick and dead livestock and poultry into the net cage; the net cage is pushed into the cracking and propagation reactors by the conveying device; the relatively small sick and dead livestock and poultry and placentas are placed into the net cage; the net cage is pushed into the cracking reactors by the conveying device; the cover sealing door is closed; and the livestock and poultry manure liquid is conveyed into the cracking and propagation reactors and the cracking reactors by sludge pumps so that the net cages are semi-immersed in the livestock and poultry manure liquid;

(3) the steam generator is started; the electromagnetic valves on steam inlet pipes of the cracking and propagation reactors and the cracking reactors are respectively opened; hot steam generated is respectively conveyed into the cracking and propagation reactors and the cracking reactors by the one-way valves so that the temperature and the pressure of the liquid in the cracking and propagation reactors and the cracking reactors are increased; the exhaust valves on the exhaust pipes of the cracking and propagation reactors and the cracking reactors are respectively closed after exhausting cold air in the cracking and propagation reactors and the cracking reactors, so that the temperature and the pressure in the cracking and propagation reactors and the cracking reactors are continuously increased to respectively reach the temperature and the pressure of statutory treatment; the sick and dead livestock and poultry and the placentas start to be cracked at high temperature and high pressure; and the detection and control system detects and controls the temperature and the pressure in the cracking and propagation reactors and the cracking reactors to keep the temperature and the pressure constant within a statutory range of the temperature and the pressure for a statutory time, so that the sick and dead livestock and poultry are completely harmless, and are disintegrated and dissolved in the manure liquid;

(4) the electromagnetic valves on steam inlet pipes of the cracking and propagation reactors and the cracking reactors are respectively closed after high-temperature and high-pressure cracking is completed, the steam generators are turned off after all the reactors complete the high-temperature and high-pressure cracking; the electromagnetic valves on the water inlet pipes of the cracking and propagation reactors and the cracking reactors are opened; the circulating water pumps on the water outlet pipes of the high-temperature thermal insulation water tanks are started; hot water respectively enters water jackets of the cracking and propagation reactors and the cracking reactors for circulation so that the cracking liquid is cooled and balanced with the temperature of the hot water in the high-temperature thermal insulation water tank; then, the electromagnetic valves on high-temperature hot water pipes are closed; the circulating water pumps on the water outlet pipes of the low-temperature thermal insulation water tanks are started; cold water enters the water jackets of the cracking and propagation reactors and the cracking reactors for circulation so that the cracking liquid is cooled to a set temperature H6; and, the circulating water pumps are turned off,

II. the cracking liquid is used as a culture medium for propagating microorganisms to obtain a microbial culture solution through propagation; and the cracking liquid is used as a raw material of the feed insect breeding for breeding feed insects.

(1) a method for propagating the microbial culture solution with the cracking liquid comprises:

<1> the electromagnetic valves on discharge pipes of the cracking reactors are opened; the cracking liquid in the cracking reactors is conveyed into the propagation reactors; pre-cultured microbial seed liquid is respectively conveyed into the reactors through feed ports of the cracking and propagation reactors and the propagation reactors; the electromagnetic valves on the aeration pipes of the cracking and propagation reactors and the propagation reactors are respectively opened; the aeration fans are started; fresh air is filtered by the air filters and then is regularly aerated to supply oxygen to the cracking and propagation reactors and, the propagation reactors; meanwhile, the detection and control system detects and controls the temperature in the reactors to keep the temperature in H5-H6, and a detection and control method comprises: the detection and control system controls to turn on the high-temperature thermal insulation water tanks to heat the cracking and propagation reactors and the propagation reactors to H6 when the detection and control system detects that the temperature in the cracking and propagation reactors and the propagation reactors is lower than a lower limit H5, and then is turned off,

<2> a propagation process is completed when the concentration of a culture bacteria solution reaches requirements after the cracking liquid is cultured and propagated for a period of time; the microbial culture solution is discharged into the liquid storage tanks through discharge valves for standing, and then is separated by an oil-water separator to obtain the microbial culture solution and grease; and the grease is used as an industrial raw material,

<3> the detection and control system detects and controls the temperature and the pressure of the materials in each reactor according to different cracking and propagation stages when a plurality of reactors react at the same time, so that the temperature and the pressure in each reactor are maintained within the set range;

(2) a method for breeding the feed insects with the cracking liquid comprises:

<1> the livestock and poultry manure is added into the cracking liquid and mixed uniformly; a mixture is used as an insect feed for breeding insects to obtain insects and ova, and is used as an animal-derived feed, which is mixed with a plant-derived feed and a commercial grain feed at a certain proportion for breeding the livestock and, poultry; and <2> the residual mixture of the cracking liquid and the livestock and poultry manure as well as frass are conveyed to the high-temperature aerobic solid fermentation reactors by the conveying device for high-temperature aerobic fermentation to obtain a solid organic fertilizer,

III. preparation of liquid organic fertilizer:

the microbial culture solution is sprayed to the aged solid organic fertilizer in a certain proportion to prepare a bio-organic fertilizer; or the microbial culture solution is added into the biogas slurry in a certain proportion to prepare a microbial liquid fertilizer, and the prepared fertilizer is respectively applied and returned to the fields according to growth demands of the feed crops;

IV. waste gas treatment:

the waste gases generated by the cracking and propagation reactors, the cracking reactors and the propagation reactors during treatment are respectively introduced into the biological deodorization filter tower by the draught fans, and are discharged after being absorbed by the bio-fillers in the biological deodorization filter tower and transformed to reach the standard

Compared with the prior art, the present invention has the advantages and beneficial effects as follows:

Breeding pollution of large-scale farms is treated according to a sustainable development treatment principle, a cycle economic treatment principle and an automation and equipment treatment principle in the present invention. The sustainable development treatment principle is an economic growth mode which pays attention to long-term development and requires not only meeting needs of contemporary people, but also not damaging the ability of future generations to meet their needs. The present invention transforms breeding wastes into resources beneficial to human beings and sustainable development for repairing and constructing environments while solving a problem of pollution from the breeding wastes by treating the breeding pollution from the sick and dead livestock and poultry. The cycle economic treatment is a management mode for a whole process aiming at reducing the quantity of substances entering a production process, repeatedly using certain articles in different ways and recycling wastes, and is waste treatment meeting needs of ecological cycle development; and the principle is mainly reflected in, three aspects of reduction, reuse and recycling. The present invention recycles manure liquid, sick and dead bodies and placentas, and utilizes nutrients in the manure liquid, sick and dead bodies and placentas to propagate functional microorganisms to finally prepare a bio-organic fertilizer to be returned to fields, or utilizes nutrients in the manure liquid, sick and dead bodies and placentas to breed feed insects to achieve the purpose of resource transformation and utilization of the waste. Moreover, the heat from the cracking and propagation system is recycled and used through heat exchange. The automation and equipment treatment principle is a principle of applying an automation technology, a remote monitoring technology and automation equipment to complete waste treatment in a closed loop, avoid projectization and engineering of treatment work, reduce interference and influence of human factors and environmental factors, and make treatment effect and quality of finished products highly consistent. The pollutants such as the sick and dead pigs, the placentas, the odor and smoke are respectively treated with the cracking and propagation reactors, the cracking reactors, the biological deodorization filter tower and other devices in the present invention, to realize equipment and standardization of the treatment processes, reduce a degree of manual participation, and improve stability and continuity of the treatment processes Meanwhile, an automatic detection and control system is utilized to realize remote real-time monitoring of equipment, processes, raw materials and products, and record destination of the pollutants in the present invention. Expert management is not required at the site due to automatic operation of the equipment and remote warning and diagnosis of the equipment are adopted. Operation conditions of the equipment at the site can be acquired from the cloud to facilitate maintenance in advance.

The cracking and propagation system designed in the present invention soaks the sick and dead livestock and poultry and the placentas in the livestock and poultry manure liquid in the closed reactors, firstly performs harmless cracking on the sick and dead livestock and poultry and the placentas at high temperature and high pressure, dissolves the sick and dead livestock and poultry and the placentas in the manure liquid, then uses the manure liquid as a culture solution for fermenting and propagating microorganisms to obtain a microbial culture solution to be sprayed into the organic fertilizer to prepare a bio-organic fertilizer, or uses the manure liquid as food for breeding insects. The innovation is as follows. (1) The pollution treatment mode is innovated in the present invention; the sick and dead livestock and poultry and the placentas are soaked in the livestock and poultry manure liquid; the cracking liquid produced from harmless treatment is used as a culture medium for culturing the microorganisms to culture the functional microorganisms to prepare a liquid agricultural microbial agent, or a culture solution is added into organic solid fertilizers to prepare the bio-organic fertilizers, thereby maximizing a resource utilization rate of the wastes. The sick and dead livestock and poultry and the placentas are rich in nutritional ingredients such as protein and fat, and major, medium and trace elements. After high-temperature and high-pressure cracking, most of the nutritional ingredients are dissolved in the cracking liquid, which can provide sufficient nutrients and inorganic salts for growth and propagation of the microorganisms. The manure liquid (that is, the excrement of livestock and poultry), and the mixture of feces and urine, contain the water more than 95%, are also rich in cellulose and protein, and contain a large amount of inorganic and organic nitrogen, which can provide a suitable liquid environment for growth and propagation of the microorganisms. The nutrients contained can also be used by the microorganisms. Compared with a traditional chemical production method, the present invention reduces processing cost of a post-drying step, and does not produce sewage pollution. Meanwhile, tail gas generated during microbial fermentation is discharged after being absorbed by the biological deodorization filter tower and transfoiined to reach a standard, and does not produce secondary pollution. (2) The cracking and propagation reactors and the cracking reactors integrate high-temperature and high-pressure cracking and microbial liquid fermentation and propagation of the sick and dead livestock and poultry to achieve multiple purposes, thereby reducing equipment and production cost and avoiding secondary pollution caused in the conveying process of the cracking liquid. (3) A plurality of aeration heads are uniformly arranged in the cracking and propagation reactors; the manure liquid and the sick and dead livestock and poultry are aerated from the bottom of the cracking and propagation reactors by using high-temperature and high-pressure steam generated by the steam generators so that the cracking and propagation system is heated up and pressurized to rapidly realize harmlessness; meanwhile, a large number of bubbles generated during aeration rub the sick and dead livestock and poultry to promote rapid disintegration of the sick and dead livestock and poultry, dissolution in the manure liquid, and increase of the content of the nutrients in the manure liquid, thereby laying a material foundation for the propagation of the microbial liquid in the next step. (4) The present invention uses the hot water generated by the continuous heating of the solar heating device as the water source of the steam generator, reduces the energy consumption generated by the steam generator that heats the cold water, shortens the steam generation time and improves the steam generation efficiency, thereby improving the cracking efficiency. After the high-temperature and high-pressure cracking of the sick and dead livestock and poultry is completed, the hot water in the high-temperature water tanks and the cold water in the low-temperature water tanks are conveyed to the water jackets of the cracking and propagation reactors for cooling the high-temperature and high-pressure cracking liquid and creating a suitable temperature condition for the microbial liquid fermentation and propagation in the next step; the heated hot water is utilized to perform thermal insulation on the microbial culture solution, thereby improving the microbial propagation efficiency; and the present invention fully uses waste heat of the cracking liquid to avoid waste of the heat, improve heating efficiency and reduce the energy consumption of heating of the system. (5) Cracking residues of the sick and dead livestock and poultry are reused; bone residue, hair and grease produced by cracking the sick and dead livestock and poultry are recovered and reused to maximize a resource conversion rate. (6) The cracking liquid is used as insect feeding food for breeding the feed insects, thereby preparing an animal-derived feed; the sick and dead livestock and poultry and the placentas are rich in nutrients such as protein, fat and inorganic salts, and are used for growth and propagation of the insects, thereby recycling the dead livestock and poultry and the placentas and also improving the insect breeding benefits and product quality.

In conclusion, the present invention creatively designs the pollution treatment equipment, innovates the treatment mode, soaks the sick and dead livestock and poultry and the placentas in the livestock and poultry manure liquid for cracking and turns waste into wealth, so that not only the sick and dead livestock and poultry and the placentas are completely harmless, but also the resource utilization rate is maximized.

### DESCRIPTION OF THE DRAWINGS

FIG. 1 is a schematic diagram of a treatment system for sick and dead livestock and poultry in the present invention;

FIG. 2 is a schematic diagram of a cracking and propagation system in the present invention;

FIG. 3 is a schematic diagram of a cross-sectional structure of a cracking and propagation reactor in the present invention;

FIG. 4 is a schematic diagram of a longitudinal section structure of a cracking and propagation reactor in the present invention;

FIG. 5 is a schematic diagram of a cross-sectional structure of a sick, and dead livestock and poultry conveying device in the present invention;

FIG. 6 is a schematic diagram of a longitudinal section structure of a sick and dead livestock and poultry conveying device in the present invention,

FIG. 7 is a structural schematic diagram of a propagation reactor in the present invention;

FIG. 8 is a schematic diagram of a heating and heat balancing system in the present invention;

FIG. 9 is a schematic diagram of connection of an aeration (steam exposure) device of a cracking and propagation reactor in the present invention;

FIG. 10 is a schematic diagram of a waste gas treatment system in the present invention; and

FIG. 11 is a schematic diagram of feed insects bred with cracking liquid in the present invention.

In the figures, 101—cracking and propagation system, 102—heating and heat balancing system, 103—waste gas treatment system, 104—detection and control system;

201—support, 202—tank body, 203—sealing cover, 204—hinge, 205—sealing ring, 206—lock, 207—water jacket, 208—aeration pipe, 209—discharge pipe, 210—circulating water inlet pipe, 211—exhaust pipe, 212—feed pipe, 213—circulating water drainage pipe, 214—electromagnetic valve, 215—aeration head; 216—guide rail, 217—temperature sensor, 218—pressure sensor, 219—safety valve, 220—thermal insulation layer;

301—cracking and propagation reactor, 302A—cracking reactor, 302B—cracking reactor, 303—livestock and poultry manure liquid, 304—microbial culture solution, 305—grease, 306—propagation reactor,

401—trolley, 402—net cage, 403—guide rail, 404—cage body, 405—steel wire mesh, 406—cage cover, 407—chain, 408—handle, 409—roller;

501—supporting leg, 502—aeration port; 503—coil circulating water outlet, 504—coil circulating water inlet, 505—feed port, 506—coil, 507—tank body, 508—exhaust port, 509—aeration device, 510—discharge port;

601—atmospheric pressure hot water boiler, 602—steam generator, 603—solar heating system, 604—high-temperature thermal insulation water tank, 605—low-temperature thermal insulation water tank, 606a—circulating water pump, 606b—circulating water pump, 606c—circulating water pump, 606d—circulating water pump, 606e—circulating water pump, 607a—electromagnetic valve, 607b—electromagnetic valve, 607c—electromagnetic valve, 607d—electromagnetic valve, 607e—electromagnetic valve, 607f—electromagnetic valve, 607g—electromagnetic valve, 607h—electromagnetic valve, 607i—electromagnetic valve, 607m—electromagnetic valve, 607n—electromagnetic valve, 607o—electromagnetic valve, 607p—electromagnetic valve, 610—steam conveying pipe,

701—animal—derived feed, 702—aerobic solid fermentation reactor, 703—organic, solid fertilizer;

801—aeration fan, 802—air filter, 803a—electromagnetic valve, 803b—electromagnetic valve, 803c—electromagnetic valve, 803d—electromagnetic valve, 804b—electromagnetic valve, 804c—electromagnetic valve, 804d—electromagnetic valve, 804e—electromagnetic valve, 805—draught fan, 806—biological deodorization filter tower, 807a—one—way valve, 807b—one-way valve, and 808—tee joint.

### DETAILED DESCRIPTION OF PREFERRED EMBODIMENTS

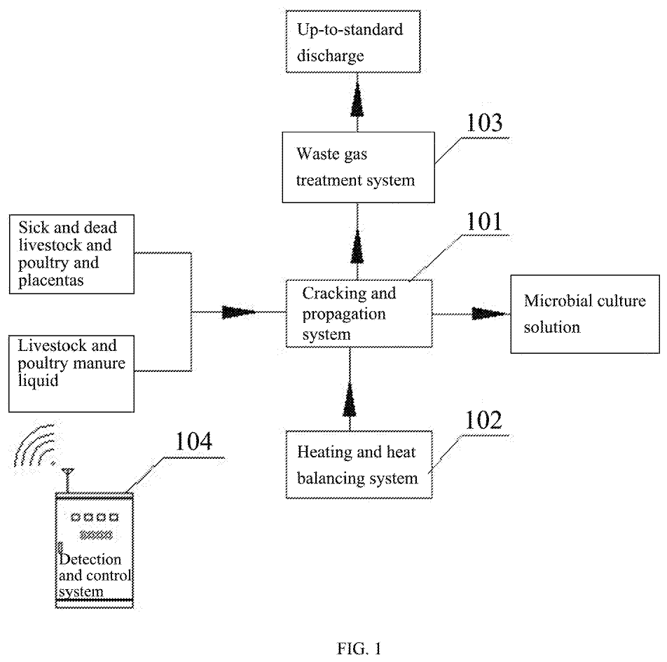

A treatment system for sick and dead livestock and poultry according to the present invention is shown in FIG. 1. The system includes a cracking and propagation system 101, a heating and heat balancing system 102, a waste gas treatment system 103 and a detection and control system 104, wherein the heating and heat balancing system 102 is connected with a water jacket and a coil of the cracking and propagation system 101 by pipes; a waste gas outlet of the cracking and propagation system 101 is connected with the waste gas treatment system 103 by pipes, sensors of the detection and control system 104 are arranged in the above systems, to detect various key parameters; and the detection and control system 104 controls connection of the above systems,

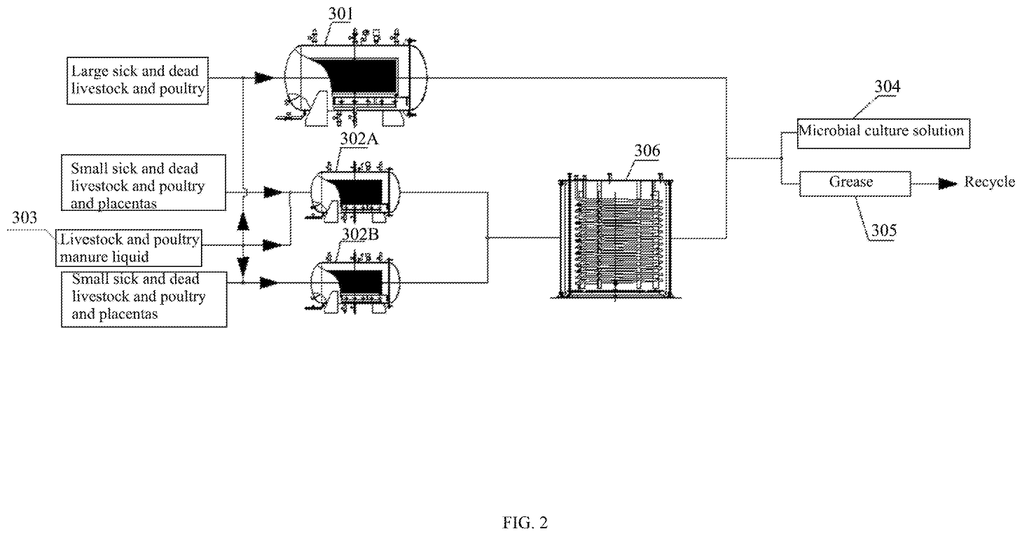

The schematic diagram of the cracking and propagation system according to the present invention is shown in FIG. 2. The cracking and propagation system 106 is mainly composed of cracking and propagation reactors 301, cracking reactors (302A and 302B), propagation reactors 306, steam generators 602, aeration fans 801, air filters 802 and connecting pipes. Livestock and poultry manure liquid is respectively connected to feed pipes 212 of the cracking and propagation reactors 301 and the cracking reactors (302A and 302B) by the conveying devices. Discharge pipes 209 of the cracking reactors (302A and 302B) are connected to feed ports 505 of the propagation reactors 306 by the conveying devices. Discharge pipes 209 of the cracking and propagation reactors 301 and discharge ports 510 of the propagation reactors 306 are respectively connected to liquid storage tanks through pipes.

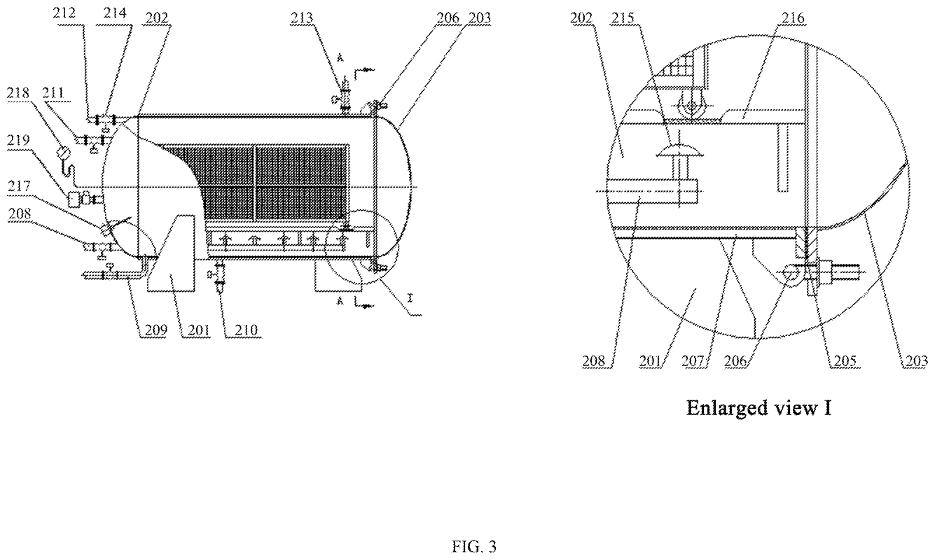

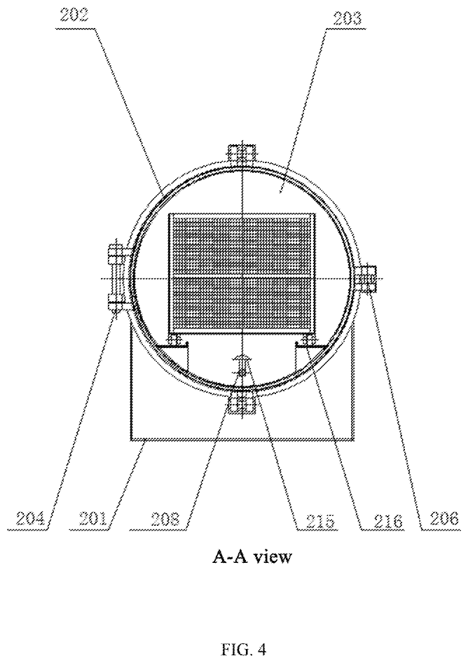

The schematic diagrams of a cross-sectional structure and a longitudinal section structure of the cracking and propagation reactor according to the present invention are shown in FIG. 3 and FIG. 4. The cracking and propagation reactor 301 is composed of a support 201, a tank body 202, a sealing cover 203 and a conveying device. The horizontally arranged tank body 202 is fixed on the support 201. One side of the tank body 202 is sealed by the sealing cover 203. A cover sealing door is mounted on the other side of the tank body 202. The cover sealing door is connected with the tank body 202 by a hinge 204. A sealing ring 205 is arranged between the cover sealing door and the tank body 202. The cover sealing door is locked and sealed with a plurality of lock 206 bolts when closed, so that a closed cracking and propagation space is formed among the sealing cover 203, the tank body 202 and the cover sealing door. Guide rails 216 parallel to an axis of the tank body 202 and radially fixed along the tank body 202 are arranged in the tank body 202 for bearing and conveying net cages 402 carrying the sick and dead livestock and poultry and the placentas. Aeration pipes 208 and a plurality of aeration heads 215 are mounted at lower parts of the guide rails 216 One end of each aeration pipe 208 is sealed, while the other end extends to the outside of the tank body by the sealing cover 203 and is sequentially connected with air outlets of the electromagnetic valve 804e, the one-way valve 807a, the air filters 802 and the aeration fan 801 and steam outlets of the electromagnetic valve 804e, the one-way valve 807b and the steam generator 602. An exhaust pipe 211 and a feed pipe 212 are arranged on an upper side of the sealing cover 203. A pressure sensor 218 and a safety valve 219 are further mounted on the upper side of the sealing cover 203. A temperature sensor 217 and a discharge pipe 209 are mounted on a lower side of the sealing cover. A water jacket 207 is mounted outside each horizontally arranged tank body 202, and the water jacket 207 is used for cooling each cracking and propagation reactor 301 A circulating water inlet pipe 210 of the water jacket 207 is arranged at a lower part of the tank body 202. A circulating water drainage pipe 213 of the water jacket 207 is arranged at an upper part of the tank body 202. The water jacket 207 is covered with, the thermal insulation layer 220 which is made of the thermal insulation material.

The cracking reactor according to the present invention is also composed of a support 201, a tank body 202, a sealing cover 203 and a conveying device. The horizontally arranged tank body 202 is fixed on the support 201. One side of the tank body 202 is sealed by the sealing cover 203. A cover sealing door is mounted on the other side of the tank body 202 The cover sealing door is connected with the tank body 202 by a hinge 204. A sealing ring 205 is arranged between the cover sealing door and the tank body 202. The cover sealing door is locked and sealed with a plurality of lock 206 bolts when closed, so that a closed cracking and propagation space is formed among the sealing cover 203, the tank body 202 and the cover sealing door. Guide rails 216 parallel to an axis of the tank body 202 and radially fixed along the tank body 202 are arranged in the tank body 202 for bearing and conveying net cages 402 carrying the sick and dead livestock and poultry and the placentas. Aeration pipes 208 and a plurality of aeration heads 215 are mounted at lower parts of the guide rails 216. One end of each aeration pipe 208 is sealed, while the other end extends to the outside of the tank body by the sealing cover 203 and is sequentially connected with steam outlets of the electromagnetic valve 804e, the one-way valve 807b and the steam generator 602. An exhaust pipe 211 and a feed pipe 212 are arranged on an upper side of the sealing cover 203. A pressure sensor 218 and a safety valve 219 are further mounted on the upper side of the sealing cover 203. A temperature sensor 217 and a discharge pipe 209 are mounted on a lower part of the sealing cover 203 A water jacket 207 is mounted outside each horizontally arranged tank body 202, and the water jacket 207 is used for cooling each cracking and propagation reactor 301. A circulating water inlet pipe 210 of the water jacket 207 is arranged at a lower part of the tank body 202. A circulating water drainage pipe 213 of the water jacket 207 is arranged at an upper part of the tank body 202. The water jacket 207 is covered with the thermal insulation layer 220 which is made of the thermal insulation material

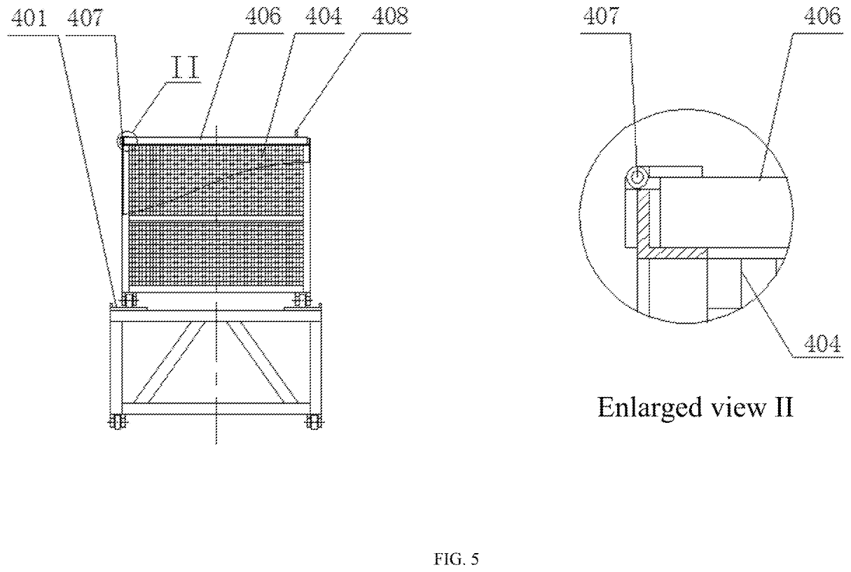

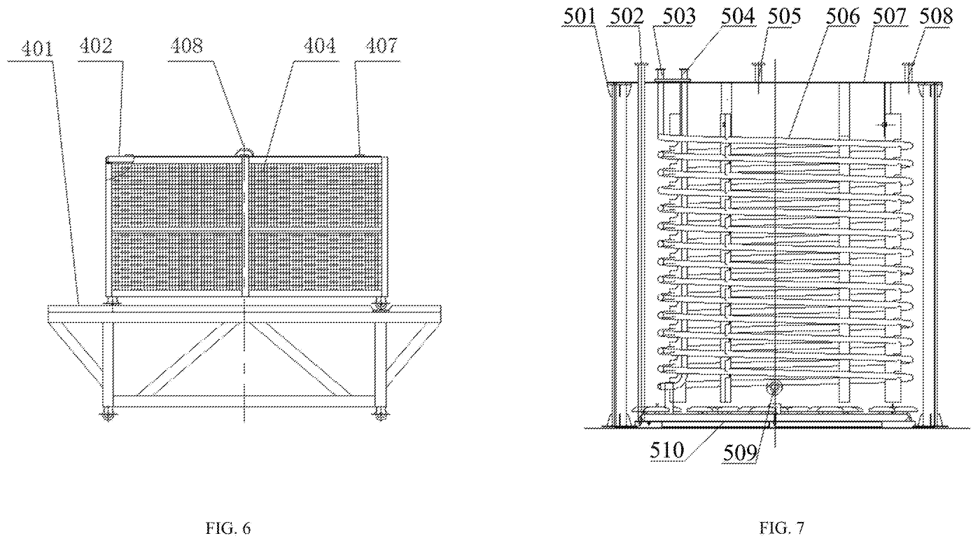

The schematic diagrams of a cross-sectional structure and a longitudinal section structure of a sick and dead livestock and poultry conveying device according to the present invention are shown in FIG. 5 and FIG. 6. The conveying device is composed of a trolley 401 and a net cage 402. A guide rail 403 is fixed at the upper part of the trolley 401 The net cage 402 is placed on the guide rail 403. The net cage 402 is a rectangular cage composed of a cage body 404 and steel wire meshes 405 The surrounding and bottom steel wire meshes 405 are welded on the cage body 404. A movable cage cover 406 is arranged at the top of the cage body 404. The cage cover 406 is connected with the cage body 404 by a chain 407. A handle 408 is further arranged outside the cage cover 406. A plurality of rollers 409 are fixed at the bottom of the cage body 404 The rollers 409 are in contact with the guide rail 403. The direction of the guide rail 403 on the trolley 401 is the same as that of the guide rail 216 in the tank body 202, and is flush with the guide rail 216 in the tank body 202 When the sick and dead livestock and poultry are conveyed, the sick and dead livestock and poultry and placentas are first placed in the net cage 402 with a forklift, and then are conveyed to a specified position in the tank body 202 by the net cage 402 along the guide rails 816 in the trolley 401 and the tank body 202

The schematic diagram of a structure of the propagation reactor according to the present invention is shown in FIG. 7. The propagation reactor 305 is composed of a vertical and closed thermal insulation tank body 507, a coil 506 and an aeration device 509. An aeration port 502, a coil circulating water outlet 503, a coil circulating water inlet 504 and an exhaust port 508 are formed in the top of the tank body 507, while a discharge port 510 is formed in the bottom of the tank body 507 The coil 506 is fixed in the tank body 507 and is immersed in the cracking liquid. The aeration device 509 is arranged at the bottom of the tank body 507. The aeration pipe extends to the outside of the tank body 507 by a tank wall and is sequentially connected with air outlets of the electromagnetic valve 804d, the one-way valve 807a, the air filter 802 and the aeration fan 801. The tank body 507 is covered with the thermal insulation layer made of the thermal insulation material.

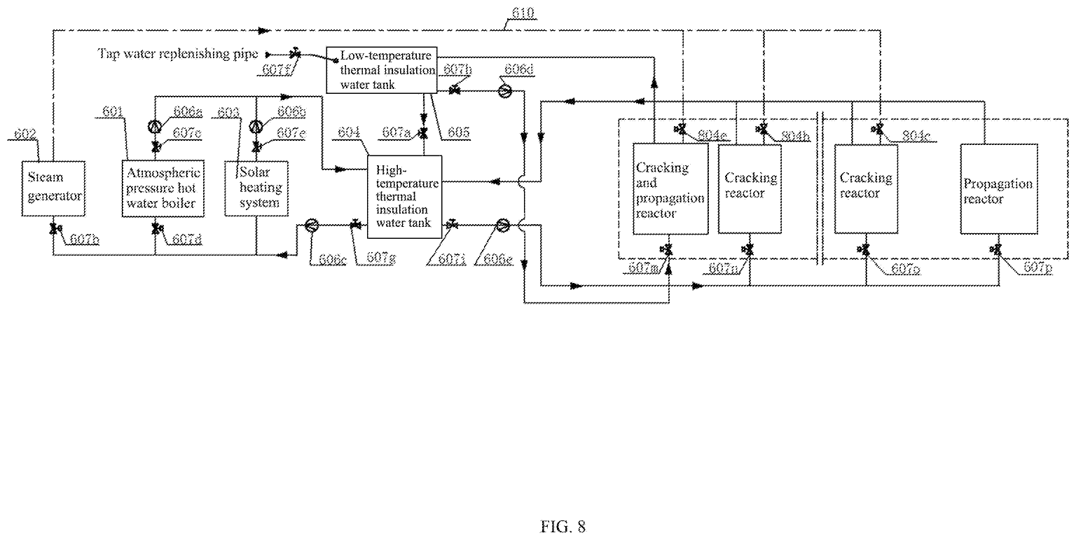

The heating and heat balancing system according to the present invention is shown in FIG. 8, and is mainly composed of an atmospheric pressure hot water boiler 601, high-temperature thermal insulation water tanks 604, low-temperature thermal insulation water tanks 605, circulating water pumps (606a-606e), electromagnetic valves (607a-607p) and connecting pipes. Further, for regions with abundant solar energy resources, the heating and heat balancing system 102 also includes a solar heating system 603. The high-temperature thermal insulation water tanks 604 are water sources of the atmospheric pressure hot water boiler 601, the solar heating system 603 and the steam generator 602. The high-temperature thermal insulation water tanks 604 respectively convey hot water to the atmospheric pressure hot water boiler 601, the solar heating system 603 and the steam generator 602 through water outlet pipes 608. The water heated by the atmospheric pressure hot water boiler 601 and the solar heating system 603 is sent back to the high-temperature thermal insulation water tanks 604 through respective pipes for realizing energy storage. The other water outlet pipe of each high-temperature thermal insulation water tank 604 is connected with the circulating water pump 606e to respectively convey the hot water to the water jackets 807 of the cracking and propagation reactors 301 and the cracking reactors (302A and 302B) Return water of the water jacket 807 of each reactor is sent back to each high-temperature thermal insulation water tank 604 through respective water returning pipes. The low-temperature thermal insulation water tanks 605 are water sources of the high-temperature thermal insulation water tanks 604. The low-temperature thermal insulation water tanks 605 are arranged above the high-temperature thermal insulation water tanks 604. The detection and control system 104 controls to open or close the electromagnetic valve 607a, and replenishes water to the high-temperature thermal insulation water tanks 604. The other water outlet pipe of each low-temperature thermal insulation water tank 605 is respectively connected with the water jackets 207 of the cracking and propagation reactors 301 and the cracking reactors (302A and 302B) by the circulating water pumps 606d The water is sent back to the low-temperature thermal insulation water tanks 604 through respective water returning pipes to realize circulation

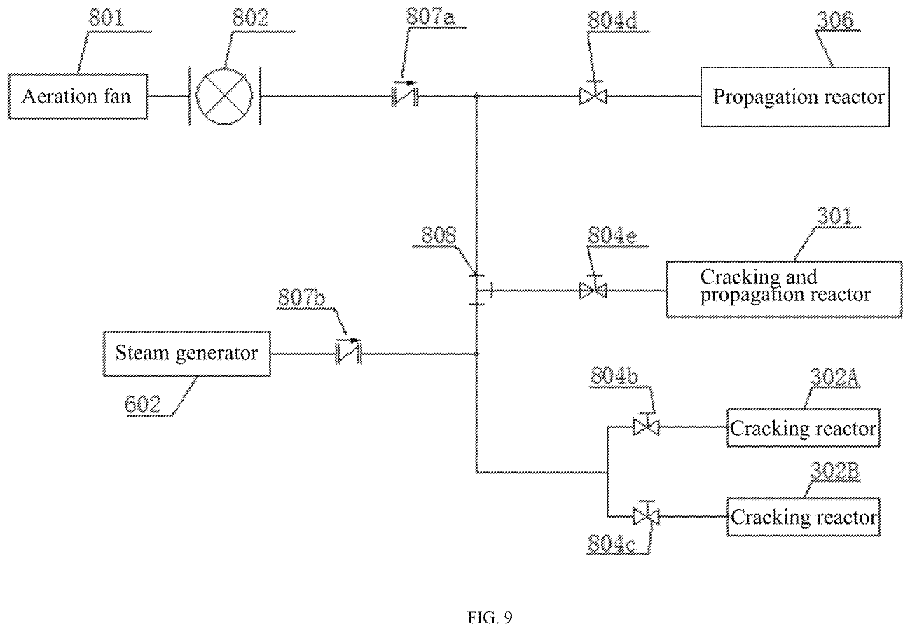

A schematic diagram of connection of an aeration (steam exposure) device of a cracking and propagation reactor in the present invention is shown in FIG. 9

Steam outlets of the steam generators 602 are respectively connected with one input port of each tee joint 808 and steam inlets of the cracking reactors (302A and 302B) by a one-way way 807b and a steam conveying pipe 610 Electromagnetic valves (804b and 804c) are respectively arranged at front ends of steam inlet pipes of the cracking reactors (302A and 302B). Air inlet ends of the aeration fans 801 are communicated with the atmosphere, and air outlet ends are respectively connected with another input port of each tee joint 808 and an air inlet of the propagation reactor 306 by the air filter 802, the one-way valve 807a and the air conveying pipe in sequence. The electromagnetic valve 804d is arranged on an air inlet pipe of each propagation reactor 306. An output end of the tee joint 808 is connected with an aeration pipe 208 of the crack and propagation reactor 301 through the pipe. The electromagnetic valve 804e is arranged on an air (steam) inlet pipe of the cracking and propagation reactor 301

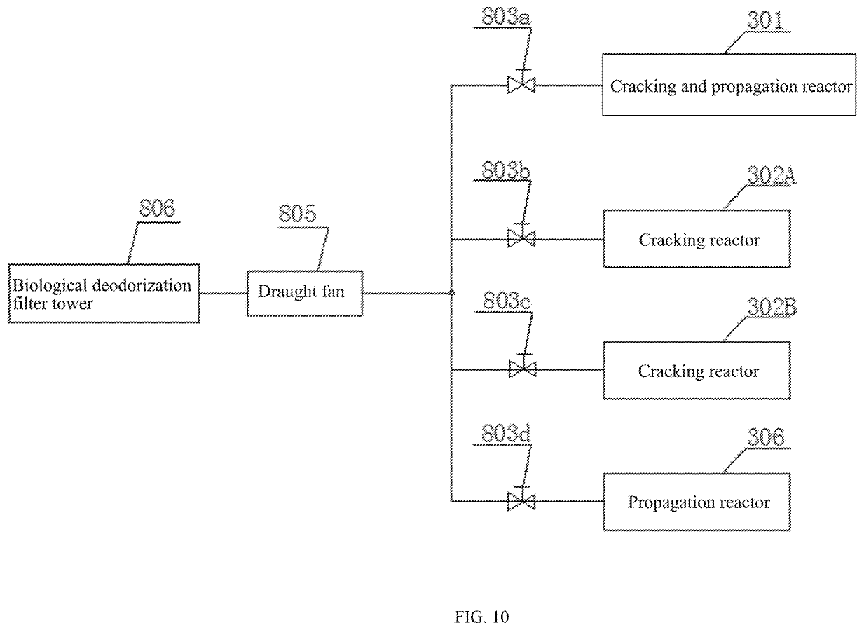

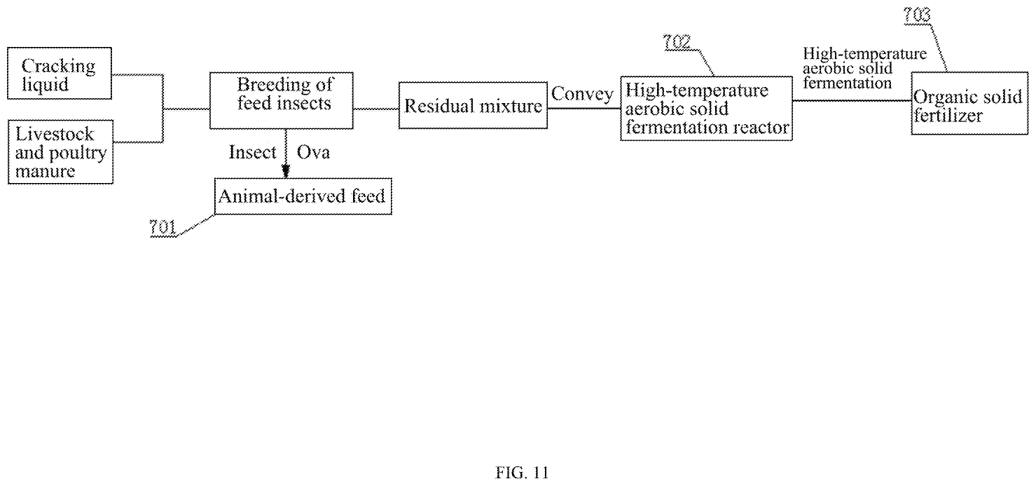

The waste gas treatment system according to the present invention is shown in FIG. 10. Exhaust pipes of the cracking and propagation reactors 301, the cracking reactors (302A and 302B) and the propagation reactors 306 are respectively connected to input ends of the draught fans 805 through the pipes. Electromagnetic valves (803a, 803b, 803c and 803d) are respectively arranged on the exhaust pipe of each reactor. The output ends of the draught fans 805 are connected with gas inlets of the biological deodorization filter towers 806 in parallel through the pipes. The exhaust ports of the biological deodorization filter towers 806 are communicated with the atmosphere through the vertical pipes.

### Embodiment 1

A treatment method based on above sick and dead pigs includes the following steps:

I. Cracking of Sick and Dead Pigs and Placentas:

(1) The electromagnetic valve 607f is opened so that tap water is automatically replenished to the low-temperature thermal insulation water tank 605; the electromagnetic valve 607a is opened so that the low-temperature thermal insulation water tank 605 automatically replenishes the water to the high-temperature thermal insulation water tank 604 by utilizing a height difference; the circulating water pump 606c is started; the electromagnetic valves (607g, 607b and 607d) are opened; the atmospheric pressure hot water boiler 601 and the solar heating system 603 are started; the water of the high-temperature thermal insulation water tank 604 is conveyed to the atmospheric pressure hot water boiler 601 and the solar heating system 603 for heating; then, the electromagnetic valves (607c and 607e) are opened; the circulating water pumps (606a and 606b) are started; and the hot water is conveyed to the high-temperature thermal insulation water tank 604 for energy storage.

(2) The forklift or other transfer equipment is used to place large sick and dead pigs into the net cage 402; the net cage 402 is pushed into the cracking and propagation reactors 301 by the conveying device; the forklift or other transfer equipment is used to place the small sick and dead pigs and placentas into another net cage 402; the net cage 402 is pushed into the cracking reactors (302A and 302B) by the conveying device, the cover sealing door is closed; and the manure liquid 303 of the pigs is conveyed into the cracking and propagation reactors 301 and the cracking reactors (302A and 302B) by the conveying pumps so that the net cages 402 are semi-immersed in the manure liquid 303 of the pigs.

(3) The electromagnetic valve 607b on the water inlet pipe of the steam generator 602 is opened; the hot water in the high-temperature thermal insulation water tank 604 is pumped into the steam generator 602; then, the steam generator 602 is started; finally, the electromagnetic valves (804e, 804b and 804c) at the front ends of the steam inlet pipes of the cracking and propagation reactors 301 and the cracking reactors (302A and 302B) are respectively opened; hot steam generated by the steam generator 602 is respectively conveyed into the cracking and propagation reactors 301 and the cracking reactors (302A and 302B) so that the temperature and the pressure of the manure liquid 303 of the pigs in the cracking and propagation reactors 301 and the cracking reactors (302A and 302B) are increased; the exhaust valves are respectively closed after exhausting cold air in the cracking and propagation reactors 301 and the cracking reactors (302A and 302B), so that the temperature and the pressure in the cracking and propagation reactors 301 and the cracking reactors (302A and 302B) respectively reach 130° C. and 0.25 Mpa; the sick and dead pigs and the placentas start to be cracked; and the detection and control system 104 detects and controls the temperature and the pressure in the cracking and propagation reactors 301 and the cracking reactors (302A and 302B) to keep them constant within 130-140° C. and 0.25-0.35 Mpa for more than 30 min, so that the sick and dead pigs and the placentas are completely harmless, and are disintegrated and dissolved in the manure liquid 303 of the pigs to obtain the cracking liquid.

(4) The steam generator 602 is turned off after high-temperature and high-pressure cracking is completed; the electromagnetic valves (607m, 607n and 607o) on water outlet pipes of the cracking and propagation reactors 301 and the cracking reactors (302A and 302B) are opened; the electromagnetic valve 607i is opened; the circulating water pump 606e is started; the hot water enters the water jackets 207 of the cracking and propagation reactors 301 and the cracking reactors (302A and 302B) for circulation to balance the temperature of the cracking liquid with the temperature of the hot water of the high-temperature thermal insulation water tank 604; then, the circulating water pump 606e and the electromagnetic valve 607i on the water outlet pipe of the high-temperature thermal insulation water tank 604 are closed; the circulating water pump 606d and the electromagnetic valve 607h on the water outlet pipe of the low-temperature thermal insulation water tank 605 are started; cold water enters the water jackets 207 of the cracking and propagation reactors 301 and the cracking reactors (302A and 302B) for circulation so that the cracking liquid is cooled to 25-35° C., and the circulating water pump 606d and the electromagnetic valve 607h are closed

(5) The electromagnetic valve on the discharge pipe of the cracking reactors (302A and 302B) is opened; and the cracking liquid in the cracking reactors (302A and 302B) is conveyed into the propagation reactor 306.

II. Propagation of the Cracking Liquid:

(1) Pre-cultured microbial seed liquid is respectively conveyed into the cracking and propagation reactor 301 and the propagation reactor 306 through the feed pipe 212 of the cracking and propagation reactor 301 and the feed port 505 of the propagation reactor 306; the aeration fan 801 is started; the detection and control system 104 respectively controls opening or closing of the electromagnetic valves (804d and 804e); sterile air filtered by the air filter 802 is respectively conveyed into the cracking and propagation reactor 301 and the propagation reactor 304; meanwhile, the detection and control system 104 detects and controls the temperature in the cracking and propagation reactor 301 and the propagation reactor 306 to respectively keep the temperature in 25-35° C.; and a detection and control method includes: <1> the detection and control system 104 controls to turn on the circulating water pump 606e on the water outlet pipe of the high-temperature thermal insulation water tank 604, the electromagnetic valve 607i is opened, and the electromagnetic valves (607m and 60′7p) are opened when the detection and control system 104 detects that the temperature in the cracking and propagation reactor 301 and the propagation reactor 306 is lower than 25° C.; the circulating water pump 606e is stopped, the electromagnetic valve 607i is closed, and the electromagnetic valves (607m and 607p) are closed when the culture solution in the cracking and propagation reactor 301 and the propagation reactor 306 is heated up to 35° C., <2> the detection and control system 104 controls to start the aeration fan 801, and the electromagnetic valves (804d and 804e) are opened to aerate the cracking and propagation reactor 301 and the propagation reactor 306 when the detection and control system 104 detects that the temperature in the cracking and propagation reactor 301 or the propagation reactor 306 exceeds 35° C., the aeration fan 801 is turned off, and the electromagnetic valves (804d and 804e) are closed when the materials in the cracking and propagation reactor 301 and the propagation reactor 306 is cooled to 25-35° C.

(2) A propagation process is completed when the concentration of a culture bacteria solution reaches requirements after the cracking liquid is cultured for 3 days; the discharge pipe 209 of the cracking and propagation reactor 301 and the discharge pipe 510 at the bottom of the propagation reactor 306 are opened; the culture solution is discharged and stored in the liquid storage tank, and then is separated by an oil-water separator to obtain the microbial culture solution 304 and grease 305; and the grease 305 is used as an industrial raw material.

(3) The detection and control system 104 respectively detects and controls the temperature and the pressure of the materials in each reactor according to different cracking and propagation stages when a plurality of cracking and propagation reactors 301, the cracking reactors (302A and 302B) and the propagation reactors 306 react at the same time, so that the temperature and the pressure in each reactor are maintained within the set ranges.

III. Preparation of Liquid Organic Fertilizer:

The microbial culture solution 304 is sprayed to the solid organic fertilizer 703 in a certain proportion to prepare a bio-organic fertilizer; or the microbial culture solution 304 is added into the biogas slurry in a certain proportion to prepare a microbial liquid fertilizer; and the prepared fertilizer is respectively applied and returned to the fields according to growth demands of the feed crops.

IV Waste Gas Treatment:

The electromagnetic valves (803a, 803b, 803c and 80d) on the exhaust pipes of the cracking and propagation reactors 301, the cracking reactors (302A and 302B) and the propagation reactor 306 are respectively opened, the waste gases generated by the reactors during treatment are respectively introduced into the biological deodorization filter tower 806 by the draught fans 805, and are discharged after being absorbed by the bio-fillers in the biological deodorization filter tower 806 and transformed to reach the standard

### Embodiment 2

A treatment method based on above sick and dead pigs includes the following steps:

I. Cracking of Sick and Dead Pigs and Placentas:

(1) The electromagnetic valve 607f is opened so that tap water is automatically replenished to the low-temperature thermal insulation water tank 605; the electromagnetic valve 607a is opened so that the low-temperature thermal insulation water tank 605 automatically replenishes the water to the high-temperature thermal insulation, water tank 604 by utilizing a height difference, the circulating water pump 606c is started; the electromagnetic valves (607g, 607b and 607d) are opened; the atmospheric pressure hot water boiler 601 and the solar heating system 603 are started; the water of the high-temperature thermal insulation water tank 604 is conveyed to the atmospheric pressure hot water boiler 601 and the solar heating system 603 for heating; then, the electromagnetic valves (607c and 607e) are opened; the circulating water pumps (606a and 606b) are started; and the hot water is conveyed to the high-temperature thermal insulation water tank 604 for energy storage

(2) The forklift or other transfer equipment is used to place large sick and dead pigs into the net cage 402; the net cage 402 is pushed into the cracking and propagation reactors 301 by the conveying device; the forklift or other transfer equipment is used to place the small sick and dead pigs and placentas into another net cage 402, the net cage 402 is pushed into the cracking reactors (302A and 302B) by the conveying device, the cover sealing door is closed; and the manure liquid 303 of the pigs is conveyed into the cracking and propagation reactors 301 and the cracking reactors (302A and 302B) by the conveying pumps so that the net cages 402 are semi-immersed in the manure liquid 303 of the pigs.

(3) The electromagnetic valve 607b on the water inlet pipe of the steam generator 602 is opened; the hot water in the high-temperature thermal insulation water tank 604 is pumped into the steam generator 602, then, the steam generator 602 is started; finally, the electromagnetic valves (804e, 804b and 804c) at the front ends of the steam inlet pipes of the cracking and propagation reactors 301 and the cracking reactors (302A and 302B) are respectively opened; hot steam generated by the steam generator 602 is respectively conveyed into the cracking and propagation reactors 301 and the cracking reactors (302A and 302B) so that the temperature and the pressure of the manure liquid 303 of the pigs in the cracking and propagation reactors 301 and the cracking reactors (302A and 302B) are increased, the exhaust valves are respectively closed after exhausting cold air in the cracking and propagation reactors 301 and the cracking reactors (302A and 302B), so that the temperature and the pressure in the cracking and propagation reactors 301 and the cracking reactors (302A and 302B) respectively reach 130° C. and 0.25 Mpa; the sick and dead pigs and the placentas start to be cracked; and the detection and control system 104 detects and controls the temperature and the pressure in the cracking and propagation reactors 301 and the cracking reactors (302A and 302B) to keep them constant within 130-140° C. and 0.25-0.35 Mpa for more than 30 min, so that the sick and dead pigs and the placentas are completely harmless, and are disintegrated and dissolved in the manure liquid 303 of the pigs to obtain the cracking liquid

(4) The steam generator 602 is turned off after high-temperature and high-pressure cracking is completed; the electromagnetic valves (607m, 607n and 607o) on water outlet pipes of the cracking and propagation reactors 301 and the cracking reactors (302A and 302B) are opened; the electromagnetic valve 607i is opened, the circulating water pump 606e is started; the hot water enters the water jackets 207 of the cracking and propagation reactors 301 and the cracking reactors (302A and 302B) for circulation to balance the temperature of the cracking liquid with the temperature of the hot water of the high-temperature thermal insulation water tank 604, then, the circulating water pump 606e and the electromagnetic valve 607i on the water outlet pipe of the high-temperature thermal insulation water tank 604 are closed, the circulating water pump 606d and the electromagnetic valve 607h on the water outlet pipe of the low-temperature thermal insulation water tank 605 are started; cold water enters the water jackets 207 of the cracking and propagation reactors 301 and the cracking reactors (302A and 302B) for circulation so that the cracking liquid is cooled to 25-35° C.; and the circulating water pump 606d and the electromagnetic valve 607h are closed

II. Breeding of the Feed Insects with the Cracking Liquid

<1> the livestock and poultry manure is added into the cracking liquid and mixed uniformly, a mixture is used as an insect feed for breeding insects to obtain insects and ova, and is used as an animal-derived feed 701, which is mixed with a plant-derived feed and a commercial grain feed at a certain proportion for breeding the livestock and poultry; and <2> the residual mixture of the cracking liquid and the livestock and poultry manure as well as frass are conveyed to the high-temperature aerobic solid fermentation reactors 702 by the conveying device for high-temperature aerobic fermentation to obtain a solid organic fertilizer 703.

III. Waste Gas Treatment:

The electromagnetic valves (803a, 803b, 803c and 80d) on the exhaust pipes of the cracking and propagation reactors 301, the cracking reactors (302A and 302B) and the propagation reactor 306 are respectively opened; the waste gases generated by the reactors during treatment are respectively introduced into the biological deodorization filter tower 806 by the draught fans 805, and are discharged after being absorbed by the bio-fillers in the biological deodorization filter tower 806 and transformed to reach the standard

I claim:

1. A treatment system for sick and dead livestock and poultry, comprising a cracking and propagation system, a heating and heat balancing system, a waste gas treatment system and a detection and control system, wherein the heating and heat balancing system is connected with a water jacket and a coil of the cracking and propagation system by pipes, a waste gas exhaust pipe of the cracking and propagation system is connected with the waste gas treatment system; sensors of the detection and control system are arranged in the corresponding systems, to detect various key parameters; and the detection and control system controls connection of the above systems,
wherein the cracking and propagation system is composed of Y cracking and propagation reactors (Y≥2), X cracking reactors (X≥1), Z propagation reactors (Z≥1), steam generators, aeration fans, air filters, electromagnetic valves and connecting pipes; livestock and poultry manure liquid is respectively inputted into feed pipes of the cracking and propagation reactors and the cracking reactors; and discharge pipes of the cracking reactors are connected to the propagation reactors; discharge pipes of the cracking and propagation reactors and the propagation reactors are respectively connected to a liquid storage tank through pipes; steam outlets of the steam generators are respectively connected with steam inlets of aeration pipes of the cracking and propagation reactors and the propagation reactors through a one-way valve, an electromagnetic valve and a steam conveying pipe, the aeration fans are connected with input ends of the air filters through pipes; and output ends of the air filters are respectively connected with another air inlet on a tee joint of the aeration pipes of the cracking and propagation reactors through a one-way valve, an electromagnetic valve and a steam conveying pipe.

2. The treatment system for sick and dead livestock and poultry according to claim 1, wherein each cracking and propagation reactor comprises a support, a tank body, a sealing cover and a conveying device; each tank body is fixed on a base; one side of each tank body is sealed by the sealing cover; a cover sealing door is mounted at the other side of each tank body; each cover sealing door is hinged to the tank body; the cover sealing door is locked and sealed with a plurality of locking bolts when closed, so that a closed cracking and propagation space is formed among the sealing cover, the tank body and the cover sealing door; the tank body is horizontally arranged; rails parallel to an axis of the tank body and radially fixed along the tank body are arranged in the tank body for bearing and conveying net cages carrying the sick and dead livestock and poultry and placentas; aeration pipes and a plurality of aeration heads are mounted at lower parts of the rails; one end of each aeration pipe is sealed, while the other end extends to the outside of the tank body by the sealing cover and is sequentially connected with air outlets of the electromagnetic valve, the one-way valve, the air filters and the aeration fan and steam outlets of the electromagnetic valve, the one-way valve and the steam generator; an exhaust pipe and a feed pipe are arranged at an upper side of each sealing cover; a pressure sensor and a safety valve are further mounted at the upper side of the sealing cover; a temperature sensor and a discharge pipe are mounted at a lower side of the sealing cover; a water jacket is mounted outside each horizontally arranged tank body for cooling each cracking and propagation reactor; a circulating water inlet pipe of the water jacket is arranged at a lower part of the tank body; a circulating water drainage pipe of the water jacket is arranged at an upper part of the tank body; and the water jacket is covered with a thermal insulation layer made of thermal insulation material.

3. The treatment system for sick and dead livestock and poultry according to claim 2, wherein each conveying device comprises a trolley and a net cage, a guide rail is fixed on the upper part of the trolley; the net cage is placed on the guide rail; the net cage is a rectangular cage composed of a cage body and steel wire meshes; the surrounding and bottom steel wire meshes are welded on the cage body; a movable cage cover is arranged at the top of the cage body; the cage cover is hinged to the cage body; a handle is further arranged outside the cage cover; a plurality of rollers are fixed at the bottom of the cage body; the rollers are in contact with the guide rail; the direction of the guide rail on the trolley is the same as that of the rail in the tank body, and is flush with the rail in the tank; and when the sick and dead livestock and poultry are conveyed, the sick and dead livestock and poultry are first placed in the net cage through a forklift, and then are conveyed to a specified position in the tank body by the net cage along the rails in the trolley and the tank body.

4. The treatment system for sick and dead livestock and poultry according to claim 1, wherein the heating and heat balancing system is composed of an atmospheric pressure hot water boiler, E high-temperature thermal insulation water tanks (E≥1), F low-temperature thermal insulation water tanks (F≥1), circulating water pumps, electromagnetic valves and connecting pipes; further, for regions with abundant solar energy resources, the heating and heat balancing system also comprises a solar heating system; the high-temperature thermal insulation water tanks are water sources of the atmospheric pressure hot water boiler, the solar heating system and the steam generator; water outlet pipes of the high temperature thermal insulation water tanks are connected with the water pumps and respectively convey hot water to the atmospheric pressure hot water boiler, the solar heating system and the steam generator; the high-temperature thermal insulation water tanks are covered with thermal insulation layers made of the thermal insulation materials, the water heated by the atmospheric pressure hot water boiler and the solar heating system is sent back to the high-temperature thermal insulation water tanks through respective pipes for realizing energy storage, the other water outlet pipe of each high-temperature thermal insulation water tank is connected with the water pump to respectively convey the hot water to the cracking and propagation reactors, the cracking reactors and the propagation reactors; return water of each reactor is sent back to each high-temperature thermal insulation water tank through respective water returning pipe; the low-temperature thermal insulation water tanks are water sources of the high-temperature thermal insulation water tanks; the low-temperature thermal insulation water tanks are arranged above the high-temperature thermal insulation water tanks and automatically replenish water to the high-temperature thermal insulation water tanks under control of the detection and control system, the other water outlet pipe of each low-temperature thermal insulation water tank is respectively connected with the water jackets of the cracking and propagation reactors and the cracking reactors through the pumps, the water is sent back to the low-temperature thermal insulation water tanks through respective water returning pipes to realize circulation; and the low-temperature thermal insulation water tanks are covered with thermal insulation layers made of the thermal insulation materials.

5. The treatment system for sick and dead livestock and poultry according to claim 1, wherein energy sources of the steam generators and the atmospheric pressure hot water boilers comprise one or more of electricity, biogas, diesel, biomass fuel, coal and solar energy.

6. The treatment system for sick and dead livestock and poultry according to claim 1, wherein the waste gas treatment system comprises draught fans, biological deodorization filter towers and connecting pipes; the aeration ports of the cracking and propagation reactors are respectively connected with the air filters and the aeration fans successively through the pipes; exhaust pipes of the cracking and propagation reactors, the cracking reactors and the propagation reactors are respectively connected to input ends of the draught fans; the output ends of the draught fans are connected with gas inlets of the biological deodorization filter towers through the pipes, and the exhaust ports of the biological deodorization filter towers are communicated with the atmosphere through the vertical pipes.

7. A treatment method based on the treatment system for sick and dead livestock and poultry according to claim 1, comprising the following steps.
I. cracking of sick and dead livestock and poultry and placentas:
(1) under control of a detection and control system, tap water is automatically replenished to low-temperature thermal insulation water tanks; the low-temperature thermal insulation water tanks automatically replenish the water to high-temperature thermal insulation water tanks by utilizing a height difference, circulating pumps of an atmospheric pressure hot water boiler and a solar heating system are started; the water of the high-temperature thermal insulation water tanks is transferred to the atmospheric pressure hot water boiler and the solar heating system by the circulating pumps for heating and then is transferred to the high-temperature thermal insulation water tanks for energy storage;
(2) a forklift or other transfer equipment is used to place relatively large sick and dead livestock and poultry into the net cage; the net cage is pushed into the cracking and propagation reactors by the conveying device; the relatively small sick and dead livestock and poultry and placentas are placed into the net cage; the net cage is pushed into the cracking reactors by the conveying device; the cover sealing door is closed; and the livestock and poultry manure liquid is conveyed into the cracking and propagation reactors and the cracking reactors by sludge pumps so that the net cages are semi-immersed in the livestock and poultry manure liquid;
(3) the steam generator is started; the electromagnetic valves on steam inlet pipes of the cracking and propagation reactors and the cracking reactors are respectively opened; hot steam generated is respectively conveyed into the cracking and propagation reactors and the cracking reactors by the one-way valves so that the temperature and the pressure of the liquid in the cracking and propagation reactors and the cracking reactors are increased; the exhaust valves on the exhaust pipes of the cracking and propagation reactors and the cracking reactors are respectively closed after exhausting cold air in the cracking and propagation reactors and the cracking reactors, so that the temperature and the pressure in the cracking and propagation reactors and the cracking reactors are continuously increased to respectively reach the temperature and the pressure of statutory treatment; the sick and dead livestock and poultry and the placentas start to be cracked at high temperature and high pressure; and the detection and control system detects and controls the temperature and the pressure in the cracking and propagation reactors and the cracking reactors to keep the temperature and the pressure constant within a statutory range of the temperature and the pressure for a statutory time, so that the sick and dead livestock and poultry are completely harmless, and are disintegrated and dissolved in the manure liquid;
(4) the electromagnetic valves on steam inlet pipes of the cracking and propagation reactors and the cracking reactors are respectively closed after high-temperature and high-pressure cracking is completed; the steam generators are turned off after all the reactors complete the high-temperature and high-pressure cracking; the electromagnetic valves on the water inlet pipes of the cracking and propagation reactors and the cracking reactors are opened; the circulating water pumps on the water outlet pipes of the high-temperature thermal insulation water tanks are started; hot water respectively enters water jackets of the cracking and propagation reactors and the cracking reactors for circulation so that the cracking liquid is cooled and balanced with the temperature of the hot water in the high-temperature thermal insulation water tank; then, the electromagnetic valves on high-temperature hot water pipes are closed; the circulating water pumps on the water outlet pipes of the low-temperature thermal insulation water tanks are started; cold water enters the water jackets of the cracking and propagation reactors and the cracking reactors for circulation so that the cracking liquid is cooled to a set temperature H6; and the circulating water pumps are turned off;
II. the cracking liquid is used as a culture medium for propagating microorganisms to obtain a microbial culture solution through propagation; and the cracking liquid is used as a raw material of the feed insect breeding for breeding feed insects;
(1) a method for propagating the microbial culture solution with the cracking liquid comprises:
<1> the electromagnetic valves on discharge pipes of the cracking reactors are opened; the cracking liquid in the cracking reactors is conveyed into the propagation reactors; pre-cultured microbial seed liquid is respectively conveyed into the reactors through feed ports of the cracking and propagation reactors and the propagation reactors; the electromagnetic valves on the aeration pipes of the cracking and propagation reactors and the propagation reactors are respectively opened, the aeration fans are started; fresh air is filtered by the air filters and then is regularly aerated to supply oxygen to the cracking and propagation reactors and the propagation reactors by the one-way valves; meanwhile, the detection and control system detects and controls the temperature in the reactors to keep the temperature in H5-H6; and a detection and control method comprises: the detection and control system controls the high-temperature thermal insulation water tanks to heat the cracking and propagation reactors and the propagation reactors to H6 when the detection and control system detects that the temperature in the cracking and propagation reactors and the propagation reactors is lower than a lower limit H5, and then is turned off;
<2> a propagation process is completed when the concentration of a culture bacteria solution reaches requirements after the cracking liquid is cultured and propagated for a period of time; the microbial culture solution is discharged into the liquid storage tanks through discharge valves for standing, and then is separated by an oil-water separator to obtain the microbial culture solution and grease; and the grease is used as an industrial raw material;
<3> the detection and control system detects and controls the temperature and the pressure of the materials in each reactor according to different cracking and propagation stages when a plurality of reactors react at the same time, so that the temperature and the pressure in each reactor are maintained within the set range;
(2) a method for breeding the feed insects with the cracking liquid comprises:
<1> the livestock and poultry manure is added into the cracking liquid and mixed uniformly; a mixture is used as an insect feed for breeding insects to obtain insects and ova, and is used as an animal-derived feed, which is mixed with a plant-derived feed and a commercial grain feed at a certain proportion for breeding the livestock and poultry; and <2> the residual mixture of the cracking liquid and the livestock and poultry manure as well as frass are conveyed to the high-temperature aerobic solid fermentation reactors by the conveying device for high-temperature aerobic fermentation to obtain a solid organic fertilizer;
III. preparation of liquid organic fertilizer:
the microbial culture solution is sprayed to the aged solid organic fertilizer in a certain proportion to prepare a bio-organic fertilizer; or the microbial culture solution is added into the biogas slurry in a certain proportion to prepare a microbial liquid fertilizer; and the prepared fertilizer is respectively applied and returned to the fields according to growth demands of the feed crops;
IV. waste gas treatment:
the waste gases generated by the cracking and propagation reactors, the cracking reactors and the propagation reactors during treatment are respectively introduced into the biological deodorization filter tower by the draught fans, and are discharged after being absorbed by the bio-fillers in the biological deodorization filter tower and transformed to reach the standard.
